(19) United States
(12) Patent Application Publication
(10) Pub. No.: US 2003/0169150 A1
(43) Pub. Date: Sep. 11, 2003

(54) Arrangement for prevention of motor vehicle thefts

(76) Inventors: Henry Tzvi Brendzel, Millburn, NJ (US); Michael Stephen Brendzel, Longmont, CO (US)

Correspondence Address: Henry T. Brendzel, P.O. Box 574, Springfield, NJ, 07081, US

(21) Appl. No.: 10/386,191

(22) Filed: Mar. 10, 2003

Related U.S. Application Data
(63) Continuation-in-part of application No. 09/274,408, filed on Mar. 23, 1999, now Pat. No. 6,531,955.

(51) Int. Cl. B60R 25/00

(52) U.S. Cl. 340/5.31; 307/10.2; 180/287; 340/426.11

(57) ABSTRACT

The risk of vehicle theft is substantially diminished with an arrangement employs a decoder that is integrally coupled to, or embedded in, one or more operating elements of a vehicle that are controlled with an electrical signal. The decoder is constructed to be responsive to an encoded signal that is generated with a security device, such as a keypad

### RELATED APPLICATIONS

This is a continuation in part of application Ser. No. 09/274,408 filed Mar. 23, 1999.

### TECHNICAL FIELD

This invention relates to control system and, more particularly, to system for preventing theft of a motor vehicle.

### DESCRIPTION OF THE PRIOR ART

Current designs for motor vehicles typically include a mechanical lock combination. The lock is engaged to a mechanical arm of an electrical switch and rotation of the arm, which is enabled by inserting a proper key in the lock and rotating the arm, in turn, enables the electrical systems that operate the vehicle's ignition. This is insufficient to prevent theft of vehicles because it is possible to gain access to the back of the lock and duplicate the switch connections with “clip” leads.

Many patents have been issued to overcome the problem of stolen vehicles, and one recent patent is U.S. Pat. No. 5,861,799, and this patent cites over two dozen other patents. None of them completely solve the aforementioned problem.

To illustrate, the '799 patent describes an arrangement where an element is interposed in the lead that normally goes from the ignition switch to circuitry that enables the operation of the vehicle. This element includes keypad 22 that is installed on a vehicle's dashboard, and a circuit board 36 that determines whether a PIN code that is entered through the keypad is correct. If it is not, the vehicle's operation is not enabled. The housing in which circuit board 36 is attached to the keypad is sealed so that it cannot be invaded. As depicted in the patent's FIG. 2, it appears that no access is available to the leads that connect keypad 22 to circuit board 36.

The output of circuit board 36 is provided via a pair of leads 32, which are extended to a solenoid in the vehicle's fuel tank. Those leads provide current for the solenoid. Specifically, when the correct PIN code is provided, current is caused to flow through leads 32 and the solenoid opens access to the engine's fuel line. When the correct PIN code is not provided, no current is caused to flow and the solenoid remains in its normal, fuel-off, position.

Alas, this forms a weak link of the system. A thief can easy gain access to leads 32, and a simple severing of leads 32 from housing 34 allows the thief to inject a current and cause the solenoid to engage and allow fuel to flow. Worse than that, one of the benefits that the '799 patent touts is the ability of a pursuing police vehicle to stop a vehicle's movement. This ability is enabled by the circuit board's ability to receive a signal from the pursuing police vehicle. Unfortunately, the above-mentioned approach for a thief to activate the solenoid also nullifies this touted ability.

Another patent, which had been cited in the parent application is U.S. Pat. No. 4,682,062 issued to Weinberger on Jul. 21, 1987. This patent interposes a switch between an ignition solenoid of a vehicle and the +12 v battery. The switch is activated to couple the battery voltage to the solenoid only by application of a preselected digital code. The switch is self-latching, which allows operation of the vehicle even after the coder has been removed. The problem with this Weinberger solution, however, is that an electrical lead that needs to be coupled to a capacitor is readily accessible, and that allows an interloper to completely circumvent the self-latching relay with a clip lead that connects the battery voltage to the solenoid.

### SUMMARY OF THE INVENTION

The problems found in prior art approaches are overcome, and an advance in the art is achieved with an arrangement that employs at least one element that requires the application of a coded signal and which cannot be made to operate normally, or be circumvented, by mere application of a DC signal to any accessible point. Recognizing the fact that no component can be made that is absolutely foolproof this at least one electromechanical element is adapted to operate even in the absence of the aforementioned coded control signal, albeit in a significantly degraded mode.

### BRIEF DESCRIPTION OF THE DRAWING

FIG. 1 illustrates an embodiment that that controls fuel flow;

FIG. 2 presents an embodiment for controlling the starter motor's relay;

FIG. 3 shows an arrangement for controlling a microprocessor that, in turn controls the operation of a vehicle; and

FIG. 4 presents an arrangement where encoding is embodied in the PIN code that needs to be applied at a keypad.

### DETAILED DESCRIPTION

A motor vehicle has various parts that contribute to the operation of the vehicle. Some are controlled mechanically, some are controlled electronically, and some are controlled with a combination of both. Almost all controls are DC in nature. That is, even in connection with components that are controlled by a microprocessor, DC control signals are applied to activate the processor, and a DC control, or a relatively simple level, or on/off, control is the result of the microprocessor computations.

In accordance with the principles of this invention, an electronic decoder is embedded in, or physically coupled to, to a key electrical terminal of a component that is necessary for normal operation of the vehicle in a manner that prevents circumventing the decoder, or the component, without very substantial amount of work. By “embedded in” we mean that the key electrical terminal, which is normally accessible to a person (mechanic, or a thief) is coupled to the decoder and is also made are essentially totally inaccessible to a person. By “essentially totally inaccessible” we mean at least that so much time is required to gain useful access to the inaccessible electrical control points, that a thief would expose himself or herself to a significant risk of being caught in the act. An electrical terminal of the component is “key” if the lack of access to the terminal cannot be traversed by application of a DC potential to some other lead, or terminal.

The embedding is further arranged so that the inputs that are applied to the decoders are not mere presentation of a battery voltage or withholding of the battery voltage, are not mere adjustable voltage levels, and are not relatively simple on/off signal sequences (e.g. such as the signals for firing spark plugs). Rather, the signals applied to the decoders are complex signals, perhaps digital, that cannot be easily mimicked by an interloper.

Correspondingly, an encoder is installed in the vehicle, or otherwise is associated with the vehicle's operator so as to develop and communicate the aforementioned complex signals to the decoder.

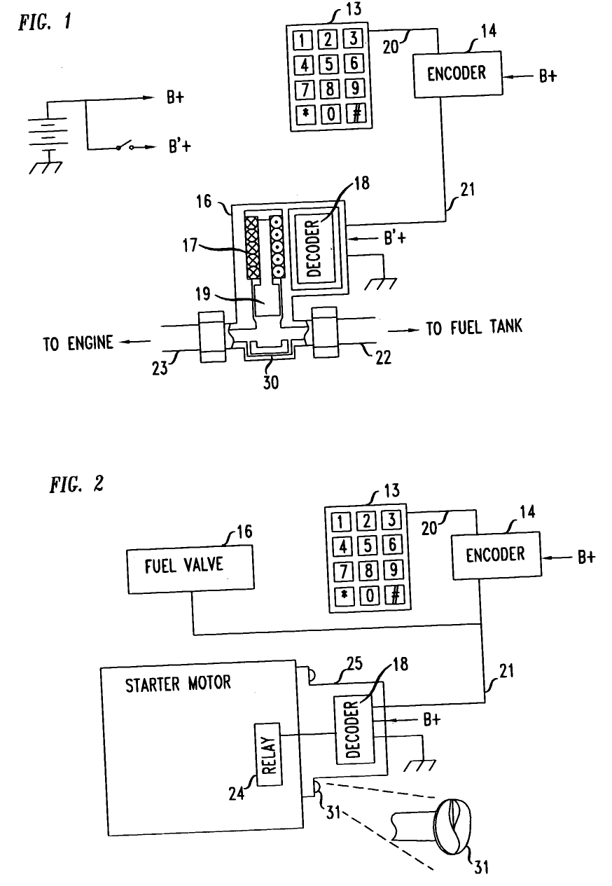

FIG. 1 presents one embodiment in conformance with the principles of this invention, where a dashboard keypad 13 communicates with encoder 14. The bundle of wires from the keypad (represented by line 20) is applied to an encoder 14, and encoder 14 outputs a signal onto line 21. Line 21 is extended to fuel control valve 16 that is interposed anywhere between the fuel tank and the fuel injection system (or vehicle carburetor). More specifically, line 21 is extended to a decoder 18 that is within valve 16.

Within fuel valve 16 there is a gate valve plunger 19 which, when it is pulled up, allows the flow of fuel from fuel line 22 to fuel line 23. Gate valve plunger 19 is pulled up by action of solenoid 17 (when current is made to flow through the solenoid). When current does not flow, a spring (not shown, for sake of clarity) forces plunger 19 to its down position, which essentially blocks the flow of fuel from line 22 to line 23.

As reliable as valve 16 is, in that it comprises only one moving part and an electronic decoder, it must be recognized that either decoder 18 or solenoid 17 may fail. It is also possible that encoder 14 may fail, or that the bona fide operator of the vehicle will forget the password that enables encoder 14. In such a case, it may be desirable to have the vehicle be less that completely disabled. Stated affirmatively, it may be desirable in such a circumstance for the vehicle to be partially operational, for example, by being able to travel only at a very low rate of speed. The rationale for this is that an interloper would not want to travel in a vehicle that conspicuously creeps along, but a bona fide operator would not mind being able to bring the vehicle to, for example, a mechanic even if it is at a snail's pace. Accordingly, one of the features disclosed herein is a means for degraded vehicle operation when, for whatever reasons, plunger 19 is not extracted to permit unimpeded fuel flow. To sake of simplicity in illustration, value 16 includes a channel 30 through which fuel can flow from the fuel tank toward the engine. Of course, instead of a separate, distinct, channel 30, one can construct solenoid 19 to fit less than snugly in its inactive position, so that some minimal amount of fuel can flow.

Advantageously, as indicated above, decoder 18 is integrally coupled to solenoid 17 and, perhaps even manufactured integrally with solenoid 17; in other words, embedded in solenoid 17. The only way to activate solenoid 17 is to provide proper signals to decoder 18. It should be understood, of course, that while valve 16 is illustratively placed between the fuel tank and the fuel injection system in FIG. 1, the integrally manufactured valve 16 can be manufactured within the fuel tank (as depicted in the aforementioned '799 patent) or within the fuel injection system.

Moreover, the decoder itself may be included in the software that controls the engine control unit (ECU) of a car, which outputs variable width pulses to the fuel injectors. The width of the pulses is a function of the throttle valve information, but in accord with the principles disclosed herein, the pulse width is controlled to some preselected narrow width value unless the appropriate code is provided to the ECU.

In FIG. 1, encoder 14 has two functions. The first one is to ascertain whether the proper PIN code was keyed-in, and the second is to provide a coded signal on line 21. The function of determining whether the proper PIN code was keyed-in is well known in the art and, therefore, is not further treated herein. As for the coding of the signal on line 21, almost any encoding will fulfill the objective of the apparatus, as long as it is complex enough. We consider a simple square wave to not be complex enough.

The signal developed by encoder 14 can be analog or digital. If analog, encoder 14 can, illustratively, generate a particular collection of tones, with particular amplitude relationships between the tones. For example, encoder 14 may develop 8 tones of different frequencies with each tone having an amplitude value between 1 and 10, in steps of 1. This provides 8¹⁰ combinations. In such an embodiment, decoder 18 comprises a plurality of narrow band filters, amplifiers to compensate for the different relative amplitudes of the tones, and comparator circuits. As long as the amplitudes of all of the compensated tones are within a specified threshold of each other, decoder 18 accepts the input signal as valid. Otherwise, it rejects the input signal as invalid. Advantageously, if the input signal is other than zero and is rejected, decoder 18 may disable itself for some relatively long time, to disallow repeated attempts at “breaking the code,” and/or activate a built in alarm. For example, an audible alarm, or a silent alarm that sends a message to the police.

It is noted that use of tones, in combination with narrow band filters and time-averaging circuitry, the effects of noise spikes can be effectively eliminated.

If encoder 14 is to operate in the digital domain, it can be designed to develop a set string of bits; for example, the string 11000101010011011100111. Decoder 18 is then tuned to accept only this string as valid, and any other applied string is considered to be an invalid attempt to “break the code.” In the above-illustrated example where the string consists of 23 bits, there are 2²³−1 viable combinations (over 8 million). It is noted that if the PIN consists of, for example, 7 digits, the communication along line 21 is more secure than the PIN code itself. That is, it would make more sense for a “want-to-be” thief to try different combinations of the PIN code than to try to apply different combinations of signals to line 21.

Decoder 18 may be designed to have one of a number of response types to a valid input signal. One type of response may be a latching of a relay, or a flip-flop to an “on” state. The relay is released, or the flip flop is reset, when the ignition key is turned off. This type of a design is reflected in FIG. 1 by the connection of the B′+ signal to decoder 18 (the voltage B′+ disappears when the ignition key is turned off, allowing the relay to unlatch, or the flip-flop to assume the “off” state). Another type of response may be a temporary latching of a relay or a flip-flop (a monostable multi-vibrator might be a good replacement for a temporarily latching flop-flop). With such a response, encoder 14 is required to repeatedly provide its enabling signal to decoder 18. This repetition rate may, for example, be once every 5 seconds. A skilled artisan can also arrange that decoder 18 must receive the repetitive application of the proper code within a time window; for example, not sooner than 4 seconds and not later than 5 second. When decoder 18 fails to receive the expected signal, it disables the operational control element that it controls. This latter type of response has some clear advantages, but also some disadvantages. The choice of the selected design is left to the practitioner.

The above disclosure, which relates to FIG. 1, is directed to the notion of controlling fuel flow. It should be understood that control of fuel flow is but one way to control whether a vehicle is operational or not. There are many points in a vehicle where reception of a signal is necessary for the vehicle to be operational. Each of these points is a candidate for applying the principles disclosed herein. For example, to start the vehicle's engine, the ignition key applies a battery voltage to a relay in the starter motor (low current path). The engaged relay applies the battery voltage to a solenoid that engages the rotor of the starter motor to the engine, and also applied the battery voltage to the stator coil of the starter motor (high current path) which turns the stator motor and the engine. An arrangement showing the engine's starter motor and its internal relay 24, is depicted in FIG. 2. An important aspect of the FIG. 2 arrangement is that decoder 18 is within a housing 25 that is integrally coupled to the starter motor (so that the battery connection to relay 24 is inaccessible, except through decoder 18). This intends to demonstrate that the benefits of this invention can be obtained by retrofitting existing vehicles. When vehicles that are already in use are to be upgraded. Of course in new vehicles, decoder 18 can be integrally manufactured within the starter motor.

Housing 25 is merely illustrative of one approach for the integral coupling of the decoder to the vehicle's component that the decoder is to enable or disable. Housing 25 can be welded to the component, or it can be connected with machine screws that can be tightened with a screwdriver but cannot be loosened with a screw driver, as depicted in FIG. 2 (the enlargement of screw head 31).

Also shown in FIG. 2 is a connection from encoder 14 to fuel valve 16. This intends to convey the notion that the principles of this invention extend to multiple decoders that may be responsive to a single encoder. A skilled artisan would realize that a plurality of encoders is also feasible, each controlling a different element and all being activated by the decoding of the PIN code.

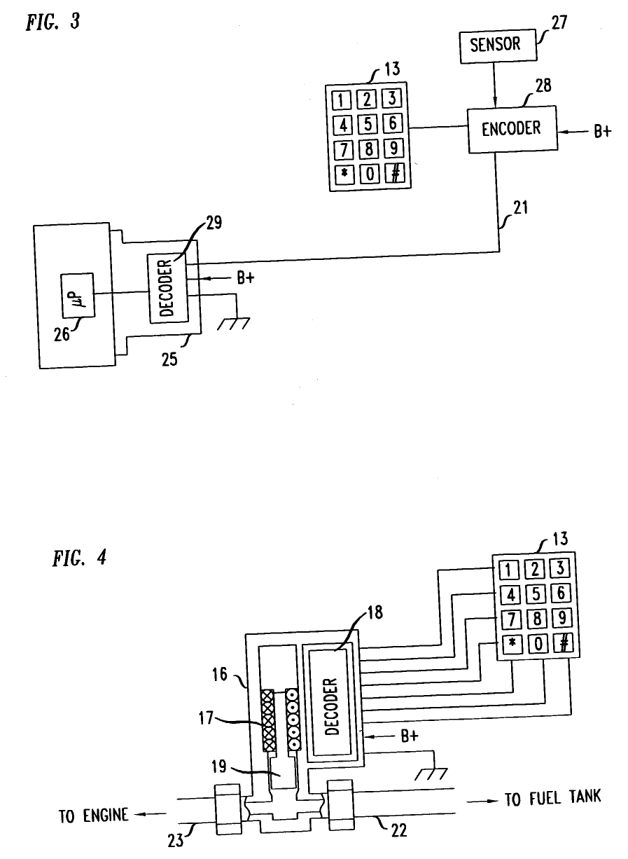

Another example is shown in FIG. 3. In this example, the point of control requires a signal other than a mere a battery voltage. In FIG. 3 this is illustrated with a lead from a microprocessor 26 that controls the vehicle's operation and is responsive to various sensors, such as sensor 27. In this embodiment, the encoder assumes a third function—that of communicating information other than “its OK to have the vehicle operational.” More specifically, encoder 28 and decoder 29 in FIG. 3 are different from encoder 14 and decoder 18 of FIG. 1 in that, in addition to the security function that is performed in the communication between the encoder and the decoder, the signal of sensor 27 must be communicated to microprocessor 26. Performing such a function is quite conventional, of course, for those who are skilled in the art of communication. Illustratively, if sensor 27 provides a changeable analog signal, encoder 28 needs to merely sense this voltage, encode it, and send the encoded signal to decoder 29. Decoder 29 decodes the signal, and recovers the analog signal of sensor 27. If the communication between encoder 28 and decoder 29 is digital, the sensing operation includes A/D conversion, the encoding may be a mere encryption of the digital signal that represents the sensor's analog voltage, the decoding is a decryption of the received signal, and recovery of the sensor's analog signal comprises conventional D/A conversion.

From the above, one may realize that it is quite easy to create an embodiment in accord with the principles of this invention where the weakest link in the security chain is the PIN combination. From this realization one can also realize that even if the leads emerging from keypad 13 are exposed, the security of the arrangement is not diminished. Extending this notion further, one might realize that applying the secret PIN code directly to decoder 18 does actually not diminish the security of the arrangement. This is illustrated in FIG. 4, where the seven leads of keypad 13 (one for each row and for each column) are applied to decoder 18.

A skilled artisan will realize that the seven keypad leads of FIG. 4 can be replaced with one lead, with the signals of the seven leads multiplexed onto a single lead with the aid of an encoder—resulting, effectively, in the arrangement depicted in FIG. 1. In other words, encoder 14 of FIG. 1 may be merely a means for multiplexing the seven signals developed by keypad 13.

Any commercially viable method for preventing theft must take into account the fact that vehicle parts can malfunction. A particular difficulty occurs when either element 15 needs to be replaced or element 16 needs to be replaced, because decoder 18 must respond to the signal of encoder 14. One solution may be for elements 15 and 16 to be sold as pairs, much like locks are sold with matching keys. Another approach is for each encoder to have a unique code that effectively specifies the particular encoding that it was manufactured with, and for each decoder to have a unique code that effectively specifies the particular encoding to which it responds. When one of the parts needs to be replaced, a person would need to buy a replacement part that has a compatible serial number.

Of course, it is not reasonable to expect that each of the multitude of stores that vehiclery vehicle parts, or even each of the multitude of dealerships of a particular vehicle make, would vehiclery the huge number of different encoders and decoders that can be manufactured. One approach for solving this problem is to manufacture programmable encoders and decoders (together with their integrally manufactured parts such as fuel valve 16). Decoder 18, for example, may be a microprocessor that accepts a given input string as the password for entering a subroutine that reprograms the decoder to accept an applied sequence as a valid sequence. A programming apparatus that is installed in a dealership can then take a virgin decoder, and program it to match a particular encoder 14 with which it will need to interact. After the decoder is programmed, the reprogramming subroutine may be erased, or disabled. The programming apparatus contains a decryption apparatus that accepts the serial number of encoder 14, decrypts it to ascertains how decoder 18 should be programmed, and appropriately programs the virgin decoder. To maintain security over the decryption apparatus, it itself can contain an enablement module that disables the apparatus unless, or until, a secret encryption key is provided—which can be so provided to the dealership by the manufacturer of the programming apparatus.

In the FIG. 4 embodiment, where there is no encoder, and decoder 18 is merely responsive to the PIN code, a replacement decoder 18 can simply specify to the purchaser the PIN code to which it responds. To activate the vehicle, the purchaser/user needs to merely employ the new PIN code. In the alternative, the purchase may specify a PIN code, and a virgin decoder can be programmed to match the desired code.

As disclosed herein, the decoder of this invention has the function of enabling or disabling the vehicle. It can have additional features as well. As indicated above, it can have an audible alarm feature. That would tend to fend off at least some thieves. It can also have a silent alarm and/or alarm and tracking feature. This feature aims to recover hijacked vehicles. For example, a driver of a vehicle who is coerced to activate the vehicle can activate the vehicle with a secondary code. The secondary code activates the vehicle and also activates a transmitter. The transmitter can even include a global positioning system receiver and include the GPS position in the transmitted signal. Decoder 18 that includes a receiver for determining the decoder's global position and a transmitter for sending this information to a chosen party, such as a police car, can be easily adapted to prevent tampering with the transmitting antenna. Since the same antenna receives the GPS information, when receptions stop, decoder 18 can disable the vehicle.

The above discloses the principles of this invention by means of a number of illustrative embodiments. It should be understood, however, that various modifications can be made, and enhancements incorporated, without departing from the spirit and scope of this invention. For example, a skilled artisan would realize that the key pad serves as a security device, and that other security devices can be employed with a similar effect. For example, a keypad 13 can be replaced with a voice response system that is trained to recognize one, or a small number of individual speakers (e.g., four drivers of a family). When a preassigned phrase is recognized by the encoder (FIG. 1) or the decoder (FIG. 4), the vehicle is enabled. Also, line 21 can be replaced with a wireless communication path between encoder 14 and decoder 18. Moreover, if encoder 14 is portable and in personal possession of the vehicle's owner, some may consider an embodiment that does not even employ a keypad.

Also, the above disclosure concentrates on the decoder disabling the vehicle's operation, or enabling it. Actually, an in-between state is quite useful as well. For example, decoder 18 can be designed so that when it fails, the car's operation is only partially disabled; i.e., allowing a vehicle to travel at not more than 10 mph; whereas when an incorrect code is presented, the vehicle is disabled completely. Of course, to achieve such a capability, the vehicle's element that is controlled must be carefully chosen. Probably, it would not be the starter motor. More likely, it would be an element in the fuel system, such as the fuel pump, or a fuel valve solenoid as described above.

What is claimed is:

1. Apparatus for attachment to a vehicle comprising
an element that is necessary for causing said vehicle to travel in normal operational mode; and
a decoder embedded in said element that enables normal operation of said element when a preselected coded signal is applied to said decoder, said decoder being embedded in a manner that prevents activation, and normal operation, of said element solely by application of a DC potential to any available lead, or terminal in said vehicle.

2. The apparatus of claim 1 where said decoder enables normal operation of said element in response to application of energy in excess of a preselected amount in a preselected set of frequencies.

3. The apparatus of claim 1 where said decoder enables normal operation of said element in response to a preselected set of digital signals.

4. The apparatus of claim 3 where said decoder enables normal operation of said element in response to a preselected set of digital signals that are repeatedly applied in accord with a preselected schema.

5. The apparatus of claim 1 where said element operates in a degraded mode in the absence of said preselected coded signal, and said degraded mode allows said vehicle to travel, but only at a preselected maximum speed.

6. The apparatus of claim 1 where said element control fuel that is applied to an engine of said vehicle.

7. The apparatus of claim 6 where said element is a fuel valve.

8. The vehicle of claim 6 where said element is a unit that control fuel injection.

9. A vehicle including an engine and various electrical and electromechanical components that control operability of said vehicle, and including a combination of an element and an associated decoder, which combination becomes operative in a normal mode upon application of a coded signal to said decoder, the improvement comprising:
said combination remains inoperative in it normal mode in spite of application of a DC signal to some accessible point, and operation of said element is not-circumvetable by application of a DC signal to some accessible point.

10. The vehicle of claim 9 where said decoder enables said normal operation upon application of energy in excess of a preselected amount in a preselected set of frequencies.

11. The vehicle of claim 9 further comprising at least one additional element-decoder combination, which additional combination becomes operative in a normal mode upon application of a coded signal to said decoder in said additional combination, and said additional combination remains inoperative in its normal operation sense in spite of application of a DC signal to some accessible point in said vehicle, and operation of said element is said additional combination is not-circumvetable by application of a DC signal to some accessible point in said vehicle.
